(19) United States
(12) Patent Application Publication
(10) Pub. No.: US 2022/0127474 A1
(43) Pub. Date: Apr. 28, 2022

(54) Peelable Swatches

(71) Applicant: PPG Industries Ohio, Inc., Cleveland, OH (US)

(72) Inventors: Alicia Marie Phelps, Gibsonia, PA (US); Inanllely Yuderka Gonzalez, Pittsburgh, PA (US); Vincent Salvatore Pagnotti, JR., Wexford, PA (US); Pansy Dhilon Patel, Murrysville, PA (US); Brian Kirk Rearick, Allison Park, PA (US); Theodore Frank Novitsky, JR., Butler, PA (US); Peter Alan Lukus, Sarver, PA (US)

(73) Assignee: PPG Industries Ohio, Inc., Cleveland, OH (US)

(21) Appl. No.: 17/429,083

(22) PCT Filed: Feb. 7, 2020
(86) PCT No.: PCT/US2020/017164

§ 371 Date: Aug. 6, 2021

Related U.S. Application Data
(60) Provisional application No. 62/802,897, filed on Feb. 8, 2019.

(51) Int. Cl. C09D 5/20; C09D 7/40; C09D 133/08; C09D 161/00; B05D 7/00

(52) U.S. Cl. CPC C09D 5/20; C09D 7/40; B05D 7/544; C09D 161/00; C09D 133/08

(57) ABSTRACT

A coating composition for and method of visualizing the appearance of a color on a substrate includes applying a coating composition having that color to the substrate, and drying and/or curing the coating composition to produce a coating in which the coating is peelable from the substrate.

### FIELD OF THE INVENTION

The present invention relates to compositions for and methods of visualizing the appearance of a color on a substrate.

### BACKGROUND OF THE INVENTION

Paint color swatches are commonly provided on a paper strip for use to select a desired color of a paint, such as an architectural paint. The small scale of such color swatches makes it difficult to visualize the use of the paint on a large area. As an alternative, an area of the substrate (e.g. a wall) may be painted with a sample of the paint. However, if that paint sample is not acceptable, the substrate bears an undesirable painted portion that must be repainted.

### SUMMARY OF THE INVENTION

The present invention comprises a method of visualizing the appearance of a color on a substrate comprising: applying a coating composition having that color to the substrate; drying and/or curing the coating composition to produce a dried and/or cured coating; evaluating the color appearance of the coating; and removing the coating from the substrate without the use of external releasing components. Also included in the present invention is a method of selecting a colored coating composition comprising visualizing the appearance of a color on a substrate in which the coating composition is a test coating composition comprising a test base resin and producing a final coating composition that color matches the test coating composition. The present invention also includes a peelable coating composition comprising an aqueous dispersion of a resinous binder comprising polyvinyl butyral, wherein the polyvinyl butyral is present in an amount of over 50 wt. %, based on total solids.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polymer, “a” colorant, and the like refer to one or more of any of these items.

As used herein, “peelable”, “peelable coating composition” “peelable coating” and like terms, means that the coating composition, upon drying and/or curing, can be peeled from the substrate; that is, the dried/cured coating is removable from the substrate by hand without the need for external releasing components such as tools (no scraper or the like) or chemicals (no paint stripper or the like) with minimal or no alteration of or damage to the underlying substrate. The coating may peel off in one sheet for ease of removal. Upon removing the coating, the substrate retains substantially no remnants of the coating, i.e. the substrate appears to be in its original state to the eye and/or to the touch.

As used herein, “external releasing components” refers to mechanical tools, such as a scraper or the like, and chemicals, such as paint stripper or the like, that can be used to remove a coating from a substrate. The term “drying” refers to the removal of water and/or other solvents. It is appreciated that drying the coating composition can also cause at least partial curing of a resinous material. Further, the terms “curable”, “cure”, and the like, mean that at least a portion of the components that make up the composition are polymerizable and/or crosslinkable including self-crosslinkable polymers. The curable coating composition of the present invention can be dried and/or cured, for example, at ambient conditions or with heat. As used herein, “ambient conditions” refers to the conditions of the surrounding environment (e.g., the temperature, humidity, and pressure of the room or outdoor environment in which the substrate is located).

Suitable substrates include porous substrates such as drywall, concrete, wood, paper (e.g. wallpaper), porcelain and ceramic and nonporous substrates such as metal, plastic, precoated porous substrates (e.g. drywall coated with a primer paint and/or a decorative paint), glass, polymeric materials, composites of any of the previous materials, and combinations thereof. A particularly suitable substrate according to the present invention is a wall or surface on the interior or exterior of a house, commercial building or other structure, that is already painted.

The present invention is described herein in connection with visualizing the appearance of a color by applying a coating composition (paint) having that color (or that dries to that color) on an architectural structure (a wall), but this is not meant to be limited as the present invention may also be used with other coating compositions on vehicles, appliances, or other substrates that can bear a coating composition. The peelable coating composition may be applied to a substrate temporarily to visualize how the substrate coated with a coating composition having that color will appear. The peelable coating composition may be applied to the substrate so the dried and/or cured coating produced from the composition is sufficiently large to provide a visual impression of the coating, such as in a two feet by three feet rectangle or any other desirable size or shape.

The peelable coating composition can include a colorant carrier, a resinous binder, and/or a plasticizer, and optionally other additives. By “colorant” it is meant to include pigments (organic or inorganic) that impart color, a hiding pigment (e.g. TiO₂), and/or color effect materials (e.g. metal flakes) as well as any other components that are typically provided in architectural paints or other such colored coating compositions. The carrier may be aqueous (e.g. water) and/or may contain an organic solvent.

A suitable resinous binder may include an acrylic latex, such as is produced from ethylenically unsaturated components that are dispersible, soluble, emulsifiable, or otherwise suspendable in water, thereby allowing the acrylic latex to form a mixture in the aqueous carrier. The ethylenically-unsaturated components may include a compound (e.g., monomer, polymers, and combinations thereof) having one or more (meth)acrylate functionalities. The term “polymer” refers to oligomers and homopolymers (e.g., prepared from a single monomer species), copolymers (e.g., prepared from at least two different monomer species), terpolymers (e.g., prepared from at least three different monomer species) and graft polymers. The term “(meth)acrylate”, as used herein, refers to an acrylate and a methacrylate functionality.

Examples of suitable compounds having one or more (meth)acrylate functionalities for use in the peelable coating composition include methyl (meth)acrylates, ethyl(meth)acrylates, propyl (meth)acrylates, butyl (meth)acrylates, 2-ethylexyl (meth)acrylates, hydroxyethyl (meth)acrylates, hydroxybutyl (meth)acrylates, cyclohexyl (meth)acrylates, acrylic acids, methacrylic acids, and combinations thereof.

Another suitable resinous binder includes polyvinyl butyral, referred to herein as PVB or PVB resin, such as a plasticized polyvinyl butyral dispersed in water. The polyvinyl butyral can be plasticized by mixing polyvinyl butyral with a plasticizer including, but not limited to, castor oil. The plasticized polyvinyl butyral can be dispersed in water with the aid of a dispersing agent.

Other additives that may be included in the peelable coating composition of the present invention include, but are not limited to, defoaming agents, biocides, rheology modifiers, and/or surfactants.

Suitable formulations for use in the peelable coating composition include: the temporary vehicle protective coating compositions disclosed in U.S. Pat. No. 2,680,724 at column 2 line 10 to column 4 line 35, which is incorporated herein by reference and spray booth coating compositions used to temporarily mask a surface inside a spray booth during spraying of another coating composition onto a component such as a vehicle. These conventional peelable protective coating compositions and masking coating compositions typically contain 30-50 weight percent (wt. %) PVB resin based on total solids. In addition, the conventional peelable protective coatings and masking coatings contain low pigment to binder weight ratios (P:B), such as less than 0.25, for example 0.1, typically with hiding pigment (e.g. titanium dioxide) or the like.

It has been found in the present invention that the concentration of PVB resin of over 50 wt. % based on total solids is desired for peelability of the coating composition comprising PVB resin from various substrates. Concentration of PVB resin in the peelable coating composition of the present invention may be at least 53 wt. % or at least 60 wt. % or at least 65 wt. % or at least 70 wt. % or at least 75 wt. % or at least 80 wt. %. The peelable coating composition of the present invention is desirably pigmented to mimic the appearance of a colored coating composition such as architectural paint at P:B ratios of at least 0.25, such as at least 0.3 or at least 0.5 or at least 0.75 or at least 1.0 or at least 1.25. In order to produce a peelable coating composition having the feel and handling of traditional architectural paints, the peelable coating composition of the present invention includes rheology modifiers, gloss control agents, colorants, and other additives as are well known in the art. For instance, the peelable coating composition may be provided as a pastel base paint, a neutral base paint and a mid-tone base paint, as are known in the architectural paint industry.

The coating composition of the present invention may also be substantially free, essentially free, or completely free of polyurethane polymers. As used herein, the terms “substantially free of polyurethane polymers” means that the coating composition contains less than 1000 parts per million (ppm) of polyurethane polymers, “essentially free of polyurethane polymers” means that the coating composition contains less than 100 ppm of polyurethane polymers, and “completely free of polyurethane polymers” means that the coating composition contains less than 20 parts per billion (ppb) of polyurethane polymers. The amounts are based on total solids weight of the coating composition.

The peelable coating composition may be applied to the substrate by brush, roll, squeeze tube, crayon, marker, ink pen, foam, gel, paste, spraying, dipping, and as an aerosol. The coating composition can be applied to the substrate in a single application using any of the previously described methods and dried and/or cured to form a coating. Alternatively, multiple applications of the coating composition can be applied to the substrate using any of the previously described methods. When multiple applications of the composition are applied to the substrate, the coating composition can be dried after each application prior to a final drying and/or curing step, or the compositions can be applied as a wet-on-wet process followed by a final drying and/or curing step.

As previously described, the coatings formed from the peelable coating compositions are removable from the substrate without the need for external releasing components such as tools (no scraper or the like) or chemicals (no paint stripper or the like) with minimal or no alteration of or damage to the underlying substrate. The coatings formed from the peelable coating compositions of the present invention can therefore be used to visualize the appearance of a color on a substrate and then easily removed with the substrate retaining substantially no remnants of the coating, i.e. the substrate appears to be in its original state to the eye and/or to the touch.

The peelable coating composition of the present invention may also be used to test the appearance of a color on a substrate and determine if the color matches a desired color. The desired color may be any color, such as one selected from a traditional color swatch available from paint suppliers, a colored article, an on-line color swatch or any other source of a color for a coating composition. According to the method of the present invention, the peelable coating composition is applied as a test coating composition to a substrate and dried and/or cured to produce a test coating. The test coating composition is formulated so that the resulting test coating color matches the desired color. By “color match”, it is meant that the test coating color is sufficiently similar to the desired color such that no difference there between is detectable by the eye. Alternatively, the color match may be confirmed via a spectrophotometer or colorimeter or other suitable device.

Typical color swatches produced by paint suppliers are flat (low or no gloss) since they are often printed with ink onto paper to mimic the color of the paint formulation when dried. A purchaser of paint may select a particular gloss level for the paint, such as eggshell, semi-gloss, gloss, etc. The peelable coating composition containing a formulation having the desired gloss level (e.g. semi-gloss) is formulated so that the dried test coating (with semi-gloss sheen) color matches the printed color swatch.

The method of the present invention may include the application of multiple peelable coating compositions each drying to a different color to test the appearance of multiple colors on a substrate. For example, the method of the present invention may include applying at least a first coating composition and a second coating composition that is different from the first coating composition to produce a first coating and a second coating. The colors provided by the first and second coatings are then compared to a desired color.

It will be appreciated that the test coating composition used to produce the test coating may not be desirable as the final coating composition applied to the substrate because the test coating is peelable. As such, the present invention also includes a method of selecting a colored coating composition comprising applying a test coating composition comprising a test base resin to the substrate as previously described, and then producing a final coating composition that color matches the test coating composition. The final coating composition comprises a final base resin that may be the same or different from the test base resin.

The present invention also includes the following aspects.

A first aspect is directed to a method of visualizing the appearance of a color on a substrate comprising applying a coating composition having that color to the substrate, drying and/or curing the coating composition to produce a coating, evaluating the color appearance of the coating, and removing the coating from the substrate without the use of external releasing components.

A second aspect is directed to the method of the first aspect, wherein the coating composition comprises a colorant.

A third aspect is directed to the method of the first or second aspects, wherein the coating composition comprises an acrylic resin.

A fourth aspect is directed to the method of any one of the first through third aspects, wherein the coating composition is substantially free of polyurethane polymers, based on the total solids weight of the coating composition.

A fifth aspect is directed to any one of the first through fourth aspects, wherein the coating composition is aqueous.

A sixth aspect is directed to the method of the first aspect, wherein the coating composite comprises polyvinyl butyral.

A seventh aspect is directed to any one of the first through sixth aspects, wherein the substrate is porous.

An eighth aspect is directed to the substrate of the seventh aspect, wherein the porous substrate comprises dry wall, concrete, wood, porcelain, and/or ceramic.

A ninth aspect is directed to any one of the first through eighth aspects, wherein the substrate is at least partially coated with a paint prior to application of the coating composition and the coating is removable from the painted substrate without damage to the paint.

A tenth aspect is directed to any one of the first through ninth aspects, wherein the coating forms a test coating and the test coating color matches a desired color.

An eleventh aspect is directed to any one of the first through tenth aspects, wherein the desired color is the color of a physical sample swatch.

A twelfth aspect is directed to any one of the first through eleventh aspects, wherein the desired color is the color of an online color sample.

A thirteenth aspect is directed to any one of the first through twelfth aspects, wherein the method further comprises applying a second coating composition and drying and/or curing the second coating composition to produce a second coating.

A fourteenth aspect is directed to any one of the first through thirteenth aspects, further comprising comparing the first and second coatings.

A fifteenth aspect is directed to a method of selecting a colored coating composition comprising visualizing the appearance of a color on a substrate according to the method of the first aspect, wherein the coating composition is a test coating composition comprising a test base resin; and producing a final coating composition that color matches the test coating composition.

A sixteenth aspect is directed to the method of the fifteenth aspect, wherein the test coating composition is dried and/or cured to form a test coating that color matches a desired color that is the color of a physical sample swatch.

A seventeenth aspect is directed to the method of any one of the fifteenth through sixteenth aspects, wherein the test coating composition is dried and/or cured to form a test coating that color matches a desired color that is the color of an online color sample.

An eighteenth aspect is directed to a peelable coating composition comprising an aqueous dispersion of a resinous binder comprising polyvinyl butyral, wherein the polyvinyl butyral is present in an amount of over 50 wt. %, based on total solids.

A nineteenth aspect is directed to the peelable coating composition of the eighteenth aspect, further comprising a pigment, wherein the weight ratio of pigment to binder (P:B ratio) is over 0.25.

A twentieth aspect is directed to the peelable coating composition of any one of the eighteenth or nineteenth aspects, further comprising a plasticizer.

### EXAMPLES

The following examples are presented to demonstrate the general principles of the invention. The invention should not be considered as limited to the specific examples presented. All parts and percentages in the examples are by weight unless otherwise indicated.

### Example 1-3: Peelable Coating Compositions

A peelable coating composition was prepared from the components listed in Table 1.

TABLE 1

| Component | Amount (grams) |
|---|---|
| BoothStrip ™ TM (ZR5955)-White¹ | 979.53 |
| PPG Futurity ™ C Zero VOC Colorant (yellow oxide)² | 8.97 |
| PPG Futurity ™ D Zero VOC Colorant (phalo green)² | 6.71 |

¹A water-based peelable plastic film, available commercially from Matthews Paint, Delaware, OH.
²An architectural colorant system, available commercially from PPG Paints, Pittsburgh, PA.

The components listed in Table 1 were added to a quart sized paint can and mixed on a Red Devil 1400 single arm paint shaker until a constant color was reached (approximately three minutes).

### Example 2

### Application of the Peelable Coating Compositions to a Substrate

The peelable composition of Example 1 was applied with a 2.5 inch angle sash brush over three panels (1A, 1B, and 1C) coated with an interior latex paints as shown in Table 2 having varying sheens of satin, flat and semi-gloss as are used in the architectural paint market.

TABLE 2

| Example | Sheen | Base | Dry Time |
|---|---|---|---|
| 1A | Satin | PPG MANOR HALL Interior | Approx. 15 months |
| | | (PPG1181-1 Candy Mix) ³ | |
| 1B | Flat | PITTSBURGH PAINTS | 1 Day |
| | | PARAMOUNT Interior (37- | |
| | | 2110-Pastel Base) ³ | |
| 1C | Semi-Gloss | PPG MANOR HALL Interior | 1 Day |
| | | (82-500 Bright Base) ³ | |

³ Architectural paints formed from an acrylic latex, available commercially from PPG.

After the peelable coating compositions were dry to the touch (approximately 30 minutes), a second coat of the coating composition from Example 1 was applied. The second coats were then dried (approximately 4 hours), and peeled from each panel. The coatings were peeled as a single film piece by hand without the use of tools or chemicals.

### Example 3

### Testing of the Peelable Coatings

Each of the panels coated with the peelable coating compositions of Example 1 were tested for color and gloss change of the underlying latex paint before and after the application of the peelable coating composition, using a Datacolor® 850 spectrophotometer for color change (ΔE) and a BYK micro-Tri-gloss meter for gloss change. The color change ((ΔE) of the substrate was determined after peeling. A higher ΔE value indicates a larger visible difference between the color of the substrate before and after application and peeling. Significant gloss changes are those that can be perceived by the naked eye. A shift in gloss (positively or negatively) of greater than 3 units is considered significant. Additionally, while 20° and 85° gloss were recorded, 60° gloss is generally considered the angle at which a coated surface is viewed. The results are listed in Table 3, showing that the underlying interior latex of the panels all had minimal color and loss changes after removing the peelable coatings.

TABLE 3

| | Color Change | Gloss | Gloss | Gloss |
|---|---|---|---|---|
| Example | (Δ E) | Change 20° | Change 60° | Change 85° |
| 1A | 0.64 | 0 | 0.2 | 1.9 |
| 1B | 1.16 | 0 | 0.4 | 0.1 |
| 1C | 0.72 | 0.1 | 0.8 | 1.7 |

### Examples 4-15: Peelable Coating Compositions

Formulations were made using commercial polyvinylbutyral (PVB) resins. In each of Examples 4-15, formulations were made by adding the components to a container in the order listed in respective Tables 4-15. For example, in Example 4, the order of addition was tap water, NATROSOL PLUS, disodium phosphate, etc. After the addition of MINEX (4 or 7) the formulations were each mixed with a high-shear Cowles blade for 15 minutes. The remaining ingredients were added and mixed with a low shear blade. After all components were added the formulations were then stirred for at least 30 minutes with a low shear blade.

TABLE 4

| | Amount |
|---|---|
| Component | (grams) |
| Tap water | 32.09 |
| NATROSOL PLUS⁴ 330 | 0.06 |
| Disodium phosphate, anhydrous | 0.96 |
| DOWSIL 8590⁵ | 0.96 |
| ACRYSOL DR-6600⁶ | 2.34 |
| 45% potassium hydroxide, aqueous | 2.16 |
| Tap water | 0.31 |
| ACTICIDE MBS⁷ | 1.25 |
| TAMOL⁸ 731A | 2.40 |
| Tap water | 0.31 |
| TERGITOL 15-S-9⁹ | 1.44 |
| TERGITOL 15-S-40¹⁰ (70%) | 1.44 |
| DIAFIL 540¹¹ | 7.27 |
| MINEX 4¹² | 3.12 |
| MINEX 4 | 20.78 |
| OPTIFILM ENHANCER 400¹³ | 6.71 |
| CAPSTONE FS-61¹⁴ | 0.48 |
| Tap water | 22.98 |
| TIONA 5961¹⁵ | 121.21 |
| Tap water | 0.33 |
| AQUAFLOW NHS-300¹⁶ | 0.38 |
| ACRYSOL RM-12W¹⁷ | 0.92 |
| DOWSIL 8590 | 0.77 |
| PVB resin¹⁸ | 311.36 |
| Tap water | 0.33 |
| ROPAQUE ULTRA¹⁹ | 30.49 |
| Tap water | 0.33 |
| ACRYSOL DR-6600 | 3.16 |
| POLYPHASE PW40²⁰ | 0.54 |
| DOWSIL 8590 | 1.15 |
| Tap water | 0.38 |

⁴Hydroxyethyl cellulose, available from Ashland Specialty Ingredients, Ashland, OH
⁵Rheology modifier available from Dow Chemical Company, Midland, MI
⁶Rheology modifier available from Dow Chemical Company, Midland, MI
⁷Biocide available from Thor Specialties, Shelton, CT
⁸Dispersant available from Palmer Holland, North Olmstead, OH
⁹Surfactant available from Dow Chemical Company, Midland, MI
¹⁰Surfactant available from Dow Chemical Company, Midland, MI
¹¹Diatomite available from Imerys, San Jose, CA
¹²Silicate available from Three Rivers Packaging Division of The Cary Company, McKees Rocks, PA
¹³Coalescent available from Eastman Chemical Company, Kingston, TN
¹⁴Fluorosurfactant available from Chemours Company, Wilmington, DE
¹⁵Titanium dioxide slurry available from Tronox Chemicals Company, Stamford, CT
¹⁶Rheology modifier available from Ashland Specialty Ingredients, Ashland, OH
¹⁷Available from Dow Chemical Company, Midland, MI
¹⁸Polyvinyl butyral composition, produced by PPG Industries, Brazil, IN
¹⁹Hiding pigment available from Dow Chemical Company, Midland, MI
²⁰Antifungal agent available from Troy Chemical Company, Newark, NJ

TABLE 5

| | Amount |
|---|---|
| Component | (grams) |
| Tap water | 35.54 |
| NATROSOL PLUS 330 | 0.13 |
| Disodium phosphate, anhydrous | 1.04 |
| DOWSIL 8590 | 1.02 |
| ACRYSOL DR-6600 | 2.54 |
| 45% potassium hydroxide, aqueous | 2.34 |
| ACTICIDE MBS | 1.35 |
| TAMOL 731A | 2.60 |
| TERGITOL 15-S-9 | 1.56 |
| TERGITOL 15-S-40 (70%) | 1.56 |
| DIAFIL 540 | 7.90 |
| MINEX 4 | 3.39 |
| MINEX 4 | 22.58 |
| OPTIFILM ENHANCER 400 | 7.29 |
| CAPSTONE FS-61 | 0.52 |
| Tap water | 26.84 |
| TIONA 596I slurry | 164.62 |
| AQUAFLOW NHS-300 | 1.04 |
| ACRYSOL RM-12W | 1.25 |
| DOWSIL 8590 | 0.51 |
| PVB SLIM5423 | 634.30 |
| ROPAQUE ULTA | 41.41 |
| ACRYSOL DR-6600 | 4.29 |
| POLYPHASE PW40 | 0.73 |
| DOWSIL 8590 | 0.51 |

TABLE 6

| | Amount |
|---|---|
| Component | (grams) |
| Tap water | 74.19 |
| NATROSOL PLUS 330 | 0.27 |
| Disodium phosphate, anhydrous | 2.17 |
| DOWSIL 8590 | 2.12 |
| ACRYSOL DR-6600 | 5.30 |
| 45% potassium hydroxide, aqueous | 4.89 |
| ACTICIDE MBS | 2.83 |
| TAMOL 731A | 5.44 |
| TERGITOL 15-S-9 | 3.26 |
| TERGITOL 15-S-40 (70%) | 3.26 |
| DIAFIL 540 | 16.50 |
| MINEX 4 | 7.07 |
| MINEX 4 | 47.13 |
| OPTIFILM enhancer 400 | 15.22 |
| CAPSTONE FS-61 | 1.09 |
| TIONA 596I | 85.91 |
| AQUAFLOW NHS-300 | 1.09 |
| ACRYSOL RM-12W | 1.31 |
| DOWSIL 8590 | 0.53 |
| PVB resin | 662.04 |
| ROPAQUE ULTRA | 43.22 |
| Tap water | 28.02 |
| ACRYSOL DR-6600 | 4.48 |
| POLYPHASE PW40 | 0.76 |
| DOWSIL 8590 | 0.53 |

TABLE 7

| | Amount |
|---|---|
| Component | (grams) |
| Tap water | 78.49 |
| TYLOSE HX 6000 YG4²¹ | 0.14 |
| Disodium phosphate, anhydrous | 1.13 |
| DOWSIL 8590 | 2.20 |
| ACRYSOL DR-6600 | 5.61 |
| 45% potassium hydroxide, aqueous | 2.83 |
| ACTICIDE MBS | 1.64 |
| TAMOL 731A | 6.79 |
| TERGITOL 15-S-40 (70%) | 1.70 |
| TERGITOL 15-S-9 | 1.70 |
| MINEX 4 | 45.27 |
| DIAFIL 540 | 16.85 |
| MINEX 3²² | 44.99 |
| TIONA 596 | 155.07 |
| OPTIFILM ENHANCER 400 | 8.49 |
| CAPSTONE FS-61 | 0.57 |
| ACRYSOL RM-12W | 4.01 |
| PVB resin | 679.04 |
| Tap water | 49.09 |
| DOWSIL 8590 | 1.10 |
| ACRYSOL DR-6600 | 8.54 |
| DOWSIL 8590 | 1.10 |
| ACTICIDE IPW 40²³ | 0.79 |

²¹Hydroxyethyl cellulose, available from SE Tylose, Wiesbaden, Germany
²²Available from Three Rivers Packaging Division of The Cary Company, McKees Rocks, PA
²³Biocide, available from Thor Specialties, Shelton, CT

TABLE 8

| | Amount |
|---|---|
| Component | (grams) |
| Tap water | 35.54 |
| NATROSOL PLUS 330 | 0.13 |
| Disodium phosphate, anhydrous | 1.04 |
| DOWS1L 8590 | 1.02 |
| ACRYSOL DR-6600 | 2.54 |
| 45% potassium hydroxide, aqueous | 2.34 |
| ACTICIDE MBS | 1.35 |
| TAMOL 731A | 2.60 |
| TERGITOL 15-S-9 | 1.56 |
| TERGITOL 15-S-40 (70%) | 1.56 |
| DIAFIL 540 | 7.90 |
| MINEX 4 | 3.39 |
| MINEX 4 | 22.58 |
| OPTIFILM ENHANCER 400 | 7.29 |
| CAPSTONE FS-61 | 0.52 |
| Tap water | 26.84 |
| TIONA 596I | 164.62 |
| AQUAFLOW NHS-300 | 1.04 |
| ACRYSOL RM-12W | 1.25 |
| DOWSIL 8590 | 0.51 |
| PVB resin | 634.30 |
| ROPAQUE ULTRA | 41.41 |
| ACRYSOL DR-6600 | 4.29 |
| POLYPHASE PW40 | 0.73 |
| DOWSIL 8590 | 0.51 |

TABLE 9

| | Amount |
|---|---|
| Component | (grams) |
| Tap water | 35.54 |
| NATROSOL PLUS 330 | 0.13 |
| Disodium phosphate, anhydrous | 1.04 |
| DOWSIL 8590 | 1.02 |
| ACRYSOL DR-6600 | 2.54 |
| 45% potassium hydroxide, aqueous | 2.34 |
| ACTICIDE MBS | 1.35 |
| TAMOL 731A 2300LB | 2.6 |
| TERGITOL 15-S-9 | 1.56 |
| TERGITOL 15-S-40 | 1.56 |
| DIAFIL 540 | 7.9 |
| MINEX 4 | 3.39 |
| MINEX 4 | 22.58 |
| OPTIFILM ENHANCER 400 | 7.29 |
| CAPSTONE FS-61 | 0.52 |
| Tap water | 26.84 |
| TIONA 596I | 54.3246 |
| AQUAFLOW NHS-300 | 1.04 |
| ACRYSOL RM-12W | 1.25 |
| DOWSIL 8590 | 0.51 |
| PVB resin | 634.3 |
| ROPAQUE ULTRA | 41.41 |
| ACRYSOL DR-6600 | 4.29 |
| POLYPHASE PW40 | 0.73 |
| DOWSIL 8590 | 0.51 |

TABLE 10

| | Amount |
|---|---|
| Component | (grams) |
| Tap water | 141.78 |
| PANGEL S²⁴ | 2.40 |
| TYLOSE HX 6000 YG4 | 2.92 |
| 45% potassium hydroxide, aqueous | 0.57 |
| DOWSIL 8590 | 2.20 |
| ACTICIDE MBS | 1.51 |
| TAMOL 731A | 1.80 |
| TERGITOL 15-S-9 | 1.80 |
| TERGITOL 15-S-40 | 1.20 |
| Zinc omadine | 1.80 |
| MINEX 7²⁵ | 56.68 |
| Calcium carbonate 0.2-10 micron | 38.99 |
| DOWSIL 8590 | 1.10 |
| OXI-CURE 2000²⁶ | 3.00 |
| Tap water | 80.50 |
| COAPUR 817W²⁷ | 1.45 |
| OPTIFLO L1400²⁸ | 12.00 |
| PVB resin | 629.87 |
| ROPAQUE ULTRA | 3.60 |
| Aluminum silicate slurry | 15.00 |
| DOWSIL 8590 | 1.10 |

²⁴Rheology modifier, available from Tolsa USA, Inc., Casper, WI
²⁵Available from Three Rivers Packaging Division of The Cary Company, McKees Rocks, PA
²⁶Coalescent, available from Cargill, Inc., Minneapolis, MN
²⁷Rheology modifier, available from Coatex Arkema Group, Chester, SC
²⁸Rheology modifier, available from BYK Additives, Wesel, Germany

TABLE 11

| | Amount |
|---|---|
| Component | (grams) |
| NATROSOL PLUS 330 | 0.12 |
| Disodium phosphate, anhydrous | 0.96 |
| DOWSIL 8590 | 0.96 |
| ACRYSOL DR-6600 | 4.68 |
| 45% potassium hydroxide, aqueous | 2.16 |
| ACTICIDE MBS | 1.25 |
| TAMOL 731A | 2.40 |
| TERGITOL 15-S-9 | 1.44 |
| TERGITOL 15-S-40 | 1.44 |
| DIAFIL 540 | 7.27 |
| MINEX 4 | 23.90 |
| OPTIFILM 400 | 6.71 |
| CAPSTONE FS-61 | 0.48 |
| Tap water | 22.98 |
| TIONA 596I slurry | 121.21 |
| AQUAFLOW NHS-300 | 0.77 |
| ACRYSOL RM-12W | 1.84 |
| DOWSIL 8590 | 0.77 |
| AQUASPERSIONS PVB 519²⁹ | 311.36 |
| ROPAQUE ULTRA | 30.49 |
| Tap water | 0.33 |
| ACRYSOL DR-6600 | 6.32 |
| POLYPHASE PW40 | 0.54 |
| DOWSIL 8590 | 1.15 |
| ACRYSOL RM-12W | 8.00 |

²⁹PVB resin, available from Halifax, United Kingdom

| | Amount |
|---|---|
| Component | (grams) |
| NATROSOL PLUS 330 | 0.12 |
| Disodium phosphate, anhydrous | 0.96 |
| DOWSIL 8590 | 0.96 |
| ACRYSOL DR-6600 | 4.68 |
| 45% potassium hydroxide, aqueous | 2.16 |
| ACTICIDE MBS | 1.25 |
| TAMOL 731A | 2.4 |
| TERGITOL 15-S-9 | 1.44 |
| TERGITOL 15-S-40 | 1.44 |
| DIAFIL 540 | 7.27 |
| MINEX 4 | 23.9 |
| OPTIFILM ENHANCER 400 | 6.71 |
| CAPSTONE FS-61 | 0.48 |
| Tap water | 22.98 |
| TIONA 596I | 39.99 |
| AQUAFLOW NHS-300 | 0.77 |
| ACRYSOL RM-12W | 1.84 |
| DOWSIL 8590 | 0.77 |
| AQUASPERSIONS PVB 519 | 311.36 |
| ROPAQUE | 30.49 |
| Tap water | 0.33 |
| ACRYSOL DR-6600 | 6.32 |
| POLYPHASE PW40 | 0.54 |
| DOWSIL 8590 | 1.15 |
| ACRYSOL RM-12W | 8 |

TABLE 13

| | Amount |
|---|---|
| Component | (grams) |
| MINEX 4 | 25.27 |
| Tap water | 26.26 |
| TYLOSE HX 6000 YG4 | 0.13 |
| Disodium phosphate, anhydrous | 1.01 |
| Tap water | 1.01 |
| DREWPLUS T 4507³⁰ | 1.01 |
| Tap water | 2.02 |
| ACRYSOL DR-6600 | 5.00 |
| 45% potassium hydroxide, aqueous | 2.27 |
| ACTICIDE MBS | 1.31 |
| TAMOL 731A | 2.53 |
| Tap water | 2.58 |
| TERGITOL 15-S-9 | 1.52 |
| Tap water | 1.10 |
| TERGITOL 15-S-40 | 1.52 |
| DIAFIL 540 | 7.58 |
| Tap water | 2.02 |
| OPTIFILM 400 | 7.08 |
| CAPSTONE FS-61 | 0.51 |
| Tap water | 2.11 |
| AQUAFLOW NHS-300 | 1.01 |
| ACRYSOL RM-12W | 2.15 |
| Tap water | 20.67 |
| SHARKCOATTC12-22³¹ | 861.75 |
| ROPAQUE | 40.33 |
| Tap water | 9.66 |
| DREWPLUS T 4507 | 1.52 |
| Tap water | 2.02 |
| TIONA 5961 | 149.52 |
| DREWPLUS T 4507 | 1.01 |
| Tap water | 2.02 |
| ACRYSOL DR-6600 | 7.64 |
| ACTICIDE IPW 40 | 0.71 |

³⁰Antifoam agent, available from Ashland LLC, Wilmington, DE
³¹PVB, available from Shark Solutions, Roskilde, Denmark

TABLE 14

| | Amount |
|---|---|
| Component | (grams) |
| Tap water | 37.10 |
| TYLOSE HX 6000 YG4 | 0.13 |
| Disodium phosphate, anhydrous | 1.01 |
| DREWPLUS T 4507 | 1.01 |
| ACRYSOL DR-6600 | 5.00 |
| 45% potassium hydroxide, aqueous | 2.27 |
| ACTICIDE MBS | 1.31 |
| TAMOL 731A | 2.53 |
| TERGITOL 15-S-9 | 1.52 |
| TERGITOL 15-S-40 | 1.52 |
| DIAFIL 540 | 7.58 |
| MINEX 4 | 25.27 |
| OPTIFILM 400 | 7.08 |
| CAPSTONE FS-61 | 0.51 |
| AQUAFLOW NHS-300 | 1.01 |
| ACRYSOL RM-12W | 2.15 |
| Tap water | 34.37 |
| SHARKCOATTC12-22 | 861.75 |
| ROPAQUE ULTRA | 40.33 |
| DREWPLUS T 4507 | 1.52 |
| TIONA 596I | 49.3416 |
| DREWPLUS T 4507 | 1.01 |
| ACRYSOL DR-6600 | 7.64 |
| ACTICIDE IPW 40 | 0.71 |

TABLE 15

| | Amount |
|---|---|
| Material | (grams) |
| Tap water | 37.10 |
| TYLOSE HX 6000 YG4 | 0.13 |
| Disodium phosphate, anhydrous | 1.01 |
| DREWPLUS T 4507 | 1.01 |
| ACRYSOL DR-6600 | 5.00 |
| 45% potassium hydroxide, aqueous | 2.27 |
| ACTICIDE MBS | 1.31 |
| TAMOL 731A | 2.53 |
| TERGITOL 15-S-9 | 1.52 |
| TERGITOL 15-S-40 | 1.52 |
| DIAFIL 540 | 7.58 |
| MINEX 4 | 25.27 |
| OPTIFILM enhancer 400 | 7.08 |
| CAPSTONE FS-61 | 0.51 |
| AQUAFLOW NHS-300 | 1.01 |
| ACRYSOL RM-12W | 2.15 |
| Tap water | 34.37 |
| SHARKCOAT TC12-22 | 861.75 |
| ROPAQUE ULTRA | 40.33 |
| DREWPLUS T 4507 | 1.52 |
| TIONA 596I | 0.00 |
| DREWPLUS t 4507 | 1.01 |
| ACRYSOL DR-6600 | 7.64 |
| ACTICIDE IPW 40 | 0.71 |

Each of the formulations of Examples 4-15 were tinted to produce colored coating compositions at three tint levels of pastel, midtone, and neutral using PPG colorant 96-13000 Durable Red. Half pint samples of the formulations were tinted to achieve 4 oz. pastel (6.45 g colorant added), 12 oz. midtone (20.69 g colorant added) and 16 oz. neutral (28.57 g colorant added). Examples 4, 5, 7, 8, 11, and 13 were tinted to produce pastel colored coating compositions. Examples 6, 9, 12, and 14 were tinted to produce midtone colored coating compositions. Examples 10 and 15 were tinted to produce neutral colored coating compositions.

Substrates were tested both before the peelable coating composition was applied, as well as after the peelable coating composition was removed to determine changes in gloss and color. The formulations of Examples 4-15 were applied to the substrate using a 6 mil drawdown bar (BYK-Gardner, Columbia, Md.) and dried, resulting in thicknesses of 3-4 mils. The substrates included primed drywall (primer, flat pastel MANOR HALL, available from PPG Industries Ohio, Inc.), painted primed drywall (paint, Paramount Eggshell Pastel, available from PPG Industries Ohio, Inc.), alkyd paint (Devoe Devguard 4308 Alkyd Enamel, available from PPG Industries, Canada), and aluminum (A-36 panels from Q-Lab Corporation, Westlake, Ohio). Gloss and color change (ΔE) were measured as in Example 3.

The “peelability” of coatings produced from tinted formulations of Examples 4-15 was evaluated qualitatively on a 1-10 scale for each substrate, with the following scale:
1—Complete failure where paint crumbled, cracked, or was completely stuck to panel
3—Some of the paint peels off the panel easily, with 75% failure
5—Half of the paint peels off the panel easily, with 50% failure
7—Most of the paint peels off the panel easily, with 25% failure
10—Complete success—all of the paint peels off panel easily without crumbling, cracking or sticking

All data is reported in Tables 16-19 for the various substrates.

TABLE 16
Primed Drywall

| | Gloss | | | | | | | |
|---|---|---|---|---|---|---|---|---|
| Tinted | 20° | | 60° | | 85° | | | Peel- |
| Coating | Pre | Post | Pre | Post | Pre | Post | ΔE | ability |
| Example 4 | 1.2 | 1.1 | 2.0 | 2.0 | 0.6 | 0.5 | 6.19 | 6 |
| Example 5 | 1.2 | 1.1 | 2.1 | 2.0 | 0.7 | 0.6 | 4.19 | 9 |
| Example 6 | 1.2 | 1.2 | 2.1 | 2.0 | 0.8 | 0.6 | 3.1 | 10 |
| Example 7 | 1.2 | 1.2 | 2.1 | 2.0 | 0.7 | 0.6 | 2.33 | 9 |
| Example 8 | 1.2 | 1.2 | 2.2 | 2.0 | 0.8 | 0.6 | 3.53 | 10 |
| Example 9 | 1.2 | 1.1 | 2.0 | 2.0 | 0.6 | 0.6 | 4.81 | 10 |
| Example 10 | 1.2 | 1.1 | 2.1 | 2.0 | 0.7 | 0.6 | 4.81 | 9 |
| Example 11 | 1.2 | 1.0 | 2.0 | 9.7 | 0.7 | 22.1 | 100.42 | 1 |
| Example 12 | 1.2 | 0.8 | 2.0 | 7.4 | 0.6 | 16.5 | 104.48 | 1 |
| Example 13 | 1.2 | 1.1 | 2.1 | 2.0 | 0.7 | 0.6 | 3.1 | 7 |
| Example 14 | 1.2 | 1.1 | 2.2 | 2.0 | 0.8 | 0.6 | 3.8 | 7 |
| Example 15 | 1.2 | 1.1 | 2.2 | 2.0 | 0.8 | 0.6 | 3.72 | 7 |

TABLE 17
Primed and Painted Drywall

| | Gloss | | | | | | | |
|---|---|---|---|---|---|---|---|---|
| Tinted | 20° | | 60° | | 85° | | | Peel- |
| Coating | Pre | Post | Pre | Post | Pre | Post | ΔE | ability |
| Example 4 | 1.7 | 1.5 | 6.5 | 5.6 | 8.8 | 8 | 6.87 | 7 |
| Example 5 | 1.7 | 1.5 | 6.2 | 5.7 | 8.4 | 8.1 | 7.48 | 10 |
| Example 6 | 1.6 | 1.5 | 5.8 | 5.5 | 7 | 7.5 | 4.99 | 10 |
| Example 7 | 1.6 | 1.5 | 6 | 5.5 | 7.1 | 7.3 | 5.64 | 10 |
| Example 8 | 1.6 | 1.5 | 5.7 | 5.4 | 6.9 | 6.5 | 7.78 | 10 |
| Example 9 | 1.6 | 1.5 | 5.9 | 5.7 | 7.3 | 7.5 | 11.87 | 10 |
| Example 10 | 1.6 | 1.5 | 5.8 | 5.8 | 6.9 | 7.5 | 14.54 | 10 |
| Example 11 | 1.6 | 1.0 | 6.1 | 10.1 | 7.3 | 24.7 | 98.79 | 1 |
| Example 12 | 1.6 | 0.8 | 5.7 | 7.7 | 7.1 | 16.7 | 103.34 | 1 |
| Example 13 | 1.7 | 1.3 | 6.2 | 12.1 | 7.7 | 27.1 | 100.06 | 2 |
| Example 14 | 1.7 | 1.6 | 6.4 | 7.1 | 7.7 | 10.2 | 12.69 | 4 |
| Example 15 | 1.7 | 0.6 | 6.9 | 2.4 | 9.1 | 0.8 | 62.73 | 3 |

TABLE 18
Alkyd

| | Gloss | | | | | | | |
|---|---|---|---|---|---|---|---|---|
| Tinted | 20° | | 60° | | 85° | | | Peel- |
| Coating | Pre | Post | Pre | Post | Pre | Post | ΔE | ability |
| Example 4 | 54.8 | 32.7 | 86.2 | 31.9 | 93.4 | 85.2 | 11.59 | 9 |
| Example 5 | 53 | 42.1 | 86.7 | 68.9 | 93 | 91.9 | 2.57 | 10 |
| Example 6 | 54.2 | 42.2 | 86.7 | 70.0 | 92.6 | 90.5 | 1.59 | 10 |
| Example 7 | 57.9 | 36.7 | 85.8 | 61.7 | 92.6 | 90.9 | 5.38 | 10 |
| Example 8 | 48.8 | 41.8 | 84 | 68.1 | 94 | 91.8 | 3.42 | 10 |
| Example 9 | 56 | 44.7 | 86.5 | 75.5 | 94.1 | 94 | 0.87 | 10 |
| Example 10 | 55.1 | 45.3 | 86.3 | 80.1 | 92.6 | 94 | 0.62 | 10 |
| Example 11 | 60 | 46.7 | 87.1 | 78.5 | 95.6 | 91.9 | 0.42 | 8 |
| Example 12 | 60.9 | 43.5 | 86.4 | 82.3 | 93.5 | 95.9 | 0.56 | 7 |
| Example 13 | 51.3 | 39.2 | 86.2 | 78.1 | 94.3 | 93.7 | 0.53 | 8 |
| Example 14 | 56.7 | 40.4 | 86.3 | 82.7 | 93.9 | 94.3 | 0.53 | 9 |
| Example 15 | 57.5 | 54.7 | 86.1 | 84.8 | 94.6 | 95.6 | 0.59 | 9 |

TABLE 19
Aluminum

| | Gloss | | | | | | | |
|---|---|---|---|---|---|---|---|---|
| Tinted | 20° | | 60° | | 85° | | | Peel- |
| Coating | Pre | Post | Pre | Post | Pre | Post | ΔE | ability |
| Example 4 | 36.6 | 33 | 71.8 | 58.9 | 70.6 | 67.6 | 6.7 | 9 |
| Example 5 | 35.3 | 34.8 | 66.8 | 62.3 | 70.1 | 69.4 | 4.67 | 9 |
| Example 6 | 37 | 33.4 | 72.7 | 57.3 | 70.1 | 64.7 | 7.16 | 10 |
| Example 7 | 35 | 33 | 65.1 | 56.6 | 68.3 | 66.2 | 4.77 | 10 |
| Example 8 | 35.9 | 33.3 | 70.5 | 60.6 | 71.1 | 67.9 | 5.17 | 10 |
| Example 9 | 34.7 | 33.4 | 66.3 | 60.1 | 68.6 | 67.3 | 4.8 | 10 |
| Example 10 | 37.1 | 33 | 72.4 | 58.6 | 69.1 | 66.7 | 5.33 | 10 |
| Example 11 | 36.5 | 1.1 | 71.4 | 10.8 | 71.1 | 29.3 | 105.68 | 1 |
| Example 12 | 35.5 | 0.9 | 68.3 | 9.1 | 70.1 | 24.4 | 109.24 | 1 |
| Example 13 | 37 | 31.9 | 72.2 | 54.4 | 69.8 | 65.2 | 6.07 | 6 |
| Example 14 | 35.9 | 33 | 69.3 | 59.0 | 67.9 | 66.8 | 5.22 | 7 |
| Example 15 | 34.2 | 32.7 | 64.1 | 58.3 | 68.7 | 68.5 | 2.08 | 10 |

The impact of film thickness on peelability was tested using primed drywall. Results are show in Table 20.

TABLE 20
Primed Drywall

| | 3 mil | 6 mil | 10 mil | 15 mil |
|---|---|---|---|---|
| Example 4 | 8 | 6 | 9 | 8 |
| Example 5 | 8 | 10 | 10 | 10 |
| Example 6 | 9 | 9 | 10 | 10 |
| Example 7 | 9 | 9 | 9 | 10 |
| Example 8 | 8 | 9 | 9 | 10 |
| Example 9 | 9 | 9 | 10 | 10 |
| Example 10 | 8 | 10 | 10 | 10 |
| Example 11 | 1 | 1 | 1 | 2 |
| Example 12 | 1 | 1 | 1 | 1 |
| Example 13 | 6 | 7 | 9 | 9 |
| Example 14 | 5 | 7 | 8 | 8 |
| Example 15 | 5 | 7 | 8 | 9 |

The amount of PVB resin by weight percent (wt. %) in each example and P:B ratio is summarized in Table 21.

TABLE 21

| Example | Wt. % PVB | P:B Ratio |
|---|---|---|
| 4 | 53.8% | 1.25 |
| 5 | 65.6% | 0.83 |
| 6 | 65% | 0.68 |
| 7 | 60.8% | 1.1 |
| 8 | 65.6% | 0.83 |
| 9 | 74.1% | 0.39 |
| 10 | 62.9% | 0.56 |
| 11 | 55.6% | not determined |
| 12 | 65.1% | not determined |
| 13 | 72.2% | not determined |
| 14 | 78.8% | not determined |
| 15 | 82.5% | not determined |

All examples showed peelability over a broad range of substrate types at varying film thicknesses. The formulations of Examples 11 and 12 readily peeled only from alkyd substrate, the least porous substrate tested. It is believed that the particular contents (e.g. plasticizer, filer, etc.) of the commercial PVB resin (of unknown specifications) used in Examples 11 and 12 impacted peelability on the remaining substrates, likely due to inability to form a continuous film due to unknown and unspecified additives. Thus, those results are not meant to be limiting of the present invention. For primed drywall or primed and painted drywall, the gloss change was minimal for Examples 4-10, while the remaining formulations showed varying degrees of gloss change and color change to the substrates.

Whereas particular embodiments of this invention have been described above for purposes of illustration, it will be evident to those skilled in the art that numerous variations of the details of the present invention may be made without departing from the invention as defined in the appended claims.

The invention claimed is:

1. A method of visualizing the appearance of a color on a substrate comprising:
applying a coating composition having that color to the substrate, and
drying and/or curing the coating composition to produce a coating,
wherein the coating is peelable from the substrate.

2. The method of claim 1, wherein the coating composition comprises a colorant.

3. The method of claim 1, wherein the coating composition comprises an acrylic resin.

4. The method of claim 1, wherein the coating composition is substantially free of polyurethane polymers, based on the total solids weight of the coating composition.

5. The method of claim 1, wherein the coating composition is aqueous.

6. The method of claim 1, wherein the coating is peelable from the substrate without use of external releasing components.

7. The method of claim 1, wherein the substrate is porous.

8. The method of claim 7, wherein the porous substrate comprises dry wall, concrete, wood, porcelain, and/or ceramic.

9. The method of claim 1, wherein the substrate is at least partially coated with a paint prior to application of the coating composition and the coating is removable from the painted substrate without damage to the paint.

10. The method of claim 1, wherein the coating forms a test coating and the test coating color matches a desired color.

11. The method of claim 10, wherein the desired color is the color of a physical sample swatch.

12. The method of claim 10, wherein the desired color is the color of an online color sample.

13. The method of claim 1, further comprising:
applying a second coating composition and drying and/or curing the second coating composition to produce a second coating.

14. The method of claim 13, further comprising comparing the first and second coatings.

15. A method of selecting a colored coating composition comprising:
visualizing the appearance of a color on a substrate according to the method of claim 1, wherein the coating composition is a test coating composition comprising a test base resin; and
producing a final coating composition that color matches the test coating composition.

16. The method of claim 15, wherein the test coating composition is dried and/or cured to form a test coating that color matches a desired color that is the color of a physical sample swatch.

17. The method of claim 15, wherein the test coating composition is dried and/or cured to form a test coating that color matches a desired color that is the color of an online color sample.

18. A peelable coating composition comprising an aqueous dispersion of a resinous binder comprising polyvinyl butyral, wherein the polyvinyl butyral is present in an amount of over 50 wt. %, based on total solids.

19. The peelable coating composition of claim 18, further comprising a pigment, wherein the weight ratio of pigment to binder (P:B ratio) is at least 0.25.

20. The peelable coating composition of claim 19, further comprising a plasticizer.
